(19) United States
(12) Patent Application Publication
(10) Pub. No.: US 2009/0182770 A1
(43) Pub. Date: Jul. 16, 2009

(54) PERSONALIZATION OF CONTEXTUALLY RELEVANT COMPUTER CONTENT

(75) Inventor: Suresh Madhavan, Foster City, CA (US)

Correspondence Address: PERKINS COIE LLP, P.O. BOX 1208, SEATTLE, WA, 98111-1208, US

(73) Assignee: PointCross, Inc., Foster City, CA (US)

(21) Appl. No.: 12/352,547

(22) Filed: Jan. 12, 2009

Related U.S. Application Data
(60) Provisional application No. 61/020,654, filed on Jan. 11, 2008.

(51) Int. Cl. G06F 17/30

(52) U.S. Cl. 707/103 R; 707/E17.012

(57) ABSTRACT

An organization defined as a collection of contexts having associated roles and objects is disclosed. In one implementation, a common computing system can maintain the contexts and associated roles and objects and provide data to personal systems. In another implementation, personal systems can maintain a subset of the data to assist in indexing.

### RELATED APPLICATIONS

This Application claims priority to U.S. Provisional Patent Application No. 61/020,654, filed Jan. 11, 2008, and entitled “PERSONALIZATION OF CONTEXTUALLY RELEVANT COMPUTER CONTENT” by Suresh Madhavan, which is incorporated herein by reference.

### BACKGROUND

In a business organization, individuals, software agents or other entities may create, receive and store objects such as documents, emails and presentations. Such an organization may have offices in various cities, states and nations. Offices may assign individuals to one or more roles where they exercise the responsibilities defined by the roles.

As the organization extends over various states and nations or multiple projects, even though the titles may be the same, the individual holding the titles may hold multiple roles. The entities can collaborate and produce a numerous different objects, for example, presentations, documents and emails. The objects may be constantly changing as the objects are worked on. This can be exacerbated by the work of several entities that collaborate within the organization to produce the objects.

The objects can be stored on a centralized system for the management of the objects and the collaborative efforts of the entities. However, when traveling or otherwise having resource constraints entities may be unable to access documents stored on a centralized system. Entities may require various objects during the time that they are unable to communicate with the organization.

Some objects are pertinent to the work that the individuals are performing while traveling, whereas other documents may be less pertinent or even irrelevant. Individuals typically cannot carry all objects with them at all times on a single computing system as the centralized system may have a storage capacity significantly greater than that of the single computing system.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

An organization defined as a collection of contexts having associated roles and objects is disclosed. In one implementation, a common computing system can maintain the contexts and associated roles and objects and provide data to personal systems. In another implementation, personal systems can maintain a subset of the data to assist in indexing.

A system and various methods may provide an ontology and access to objects. A common business ontology system identifies objects and stores them in association with contexts to allow entities working within the contexts to quickly and easily identify the various objects that are associated with their work.

Typically, entities have relatively unfettered access to the common business ontology system, however, when traveling, or otherwise unable to access the common business ontology the entities may need access to at least some of the objects stored therein. Also, during times of high traffic, entities may find downloading objects takes longer.

To provide an entity with the objects needed, objects that are pertinent to the entity are automatically or on demand copied from common system to a personal system. An entity using the personal system is then free to work on the objects even if disconnected from the common system. Any new objects created or received by the personal system while the entity is disconnected from the common system are stored in association with the appropriate context. Edited objects and new objects are provided to the common system when the personal system resumes communication with the common system.

In a non-limiting example, an individual working from an office in California may collaborate with an individual working from an office in Beijing on a project. The project may be associated with a context, and all documents, emails and other objects created by the two individuals may be stored in association with the context. Either individual, or an agent for either individual may, at any time, download content from the contexts. Changes to the content may be indexed on computing devices for the individuals and later added to a common system accessible by each of the individuals.

### BRIEF DESCRIPTION OF THE DRAWINGS

FIG. 1 depicts an example of a system for providing new content to a business organization and receiving a contextualized object associated with the new content.

FIG. 2 depicts an example of a common business ontology system.

FIG. 3 depicts an example of an agent and associated modules for storing a contextualized object.

FIG. 4 depicts a flowchart of an example of a method for storing a new object in a personal system in association with a context.

FIG. 5 depicts an example of a system in which pertinent objects are provided to a resource-constrained personal system.

FIG. 6 depicts a flowchart of an example of a method for providing pertinent objects from a common system to a personal system.

FIG. 7 depicts a diagram of an example of an ontological representation of knowledge of a business organization.

FIG. 8 depicts an example of a system appropriate for implementing one or more of the systems described in this paper.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

A business organization includes a collection of projects or contexts. The collection may include independent disconnected projects; as well as interconnected projects where individual contexts of one project tree may be linked or connected to a context in another project tree. Links connect the contexts of one tree to another to represent communications, dependencies, workflow relationships, definitions, assignments, data flows, or other various relationships. The links may be built explicitly by individuals, automatically created by automated process workflows, or developed by entities in any known or convenient manner. The resulting structure of interconnected trees form the ontology of the business and it represents the knowledge state of the business.

At times, individuals may form informal organizations such as social relationships within business organizations. Individuals in such informal organization seek assistance from each other in a manner not reflected by a business hierarchy. Such individuals may not have formal authority or accountability, but trust each other. Such individuals often share common interests and contribute knowledge and experience to each other. In the business organization such individuals may refer to roles performed in the informal organization as well as the structured organization. Such valuable relationships may be recognized by identifying the roles performed by the individuals involved. In a non-limiting example, an individual could be referred to as an advisor and perform the role of mentoring an inexperienced individual while no such formal relationship exists.

An organization may be defined as a collection of contexts, and associated rules and data. As used herein, a “context” is a collection of items having a business reason to exist. A context can be associated with one or more roles performed by entities in the business organization. In a non-limiting example, financing a company, providing employee benefits, legal counseling, and any other applicable known or convenient business activity may serve as a context within an organization. Also, depending upon the implementation, each individual could be given a personal context, which can include, by way of example but not limitation, email objects when marked “personal.” Such a context may still have a role filled by a person other than the individual who regards the context as personal. For example, personal contexts may be reviewable by human resources if a complaint is received about inappropriate use of personal email. So a human resources manager may have a review role for personal contexts (perhaps with a trigger that enables review only after a certain sequence of events or approvals take place). Because personal contexts are typically owned by a company, can be associated with potential ramifications for the company, and individuals expect to be entitled to incidental personal use of company resources, personal contexts are expected to be integrated into an organization in typical implementations.

Within each context, individuals have roles. As used herein a “role” may be a purpose fulfilled by the individual with regard to a context. The role may or may not be the same as the individual's title or position. In a non-limiting example, a chief executive officer (CEO) may perform the role of interviewer for a context (e.g., hiring an employee). Such roles may be termed using dramatically different names, and such names could be in more than one language.

A taxonomy tree can be used to track various nomenclatures used in identifying roles within a business organization. As used herein a “taxonomy” tree includes relationships between one or more terms, titles, names or other identifiers to roles performed by the holders of the terms, titles, names or other identifiers. The many relationships can be used to look up roles performed by individuals.

As used herein, an “object” is any document, presentation, calendar item, communication, or other known or convenient item that may be used by an individual within a context to further the business purpose of the context. As such, the object has a business reason to exist in association with the context.

As used herein, “pertinent” is associated with a score for an object. The score will vary depending upon the range of scores possible (e.g., ‘0’ or ‘1’ in a binary scoring system, ‘0’ to ‘1’ in a real number scoring system that ranges from zero to one, ‘1’ to ‘n’ in an integer scoring system that ranges from one to n, etc.). The range is, for all practical purposes, implementation-specific. In this paper, for illustrative convenience where applicable, the score will be assumed to have a number value, and more pertinent objects will have a higher score than less pertinent objects. To determine pertinence, each object must be considered in association with tasks that a human or software entity is working on. The score is calculated using values for events related to contexts the individual will be engaged in. For example, if an individual has a first task assigned for completion tomorrow and a second task assigned for completion in 30 days, objects associated with the first task may be more pertinent than objects associated with the second task. In a system with a simple scoring range, the first task may be given a pertinence of 99 (i.e., 100 minus the number of days before the task is to be completed) and the second task may be given a pertinence of 70 (i.e., 100 minus the number of days before the task is to be completed). For illustrative convenience, this example is intentionally simplistic.

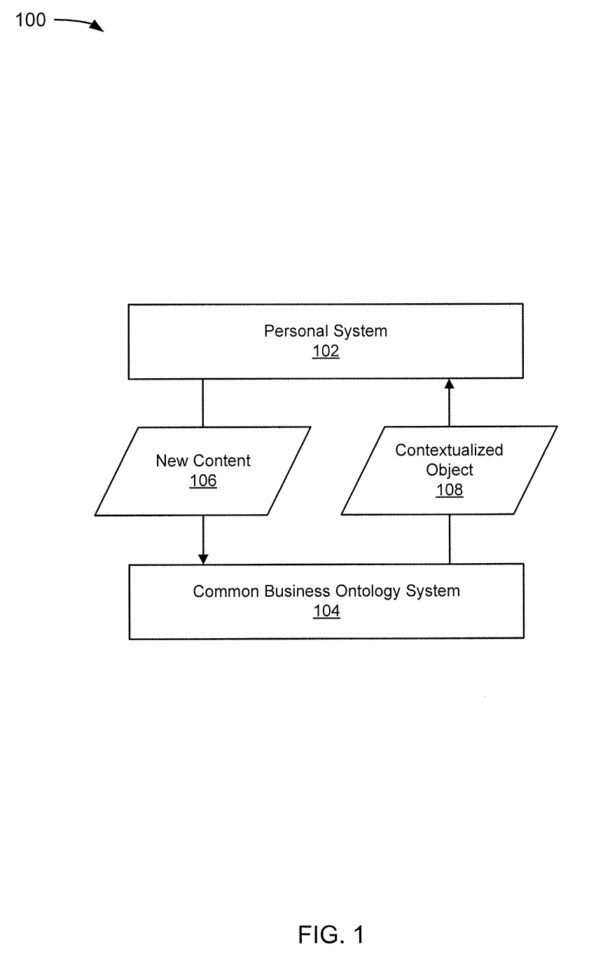

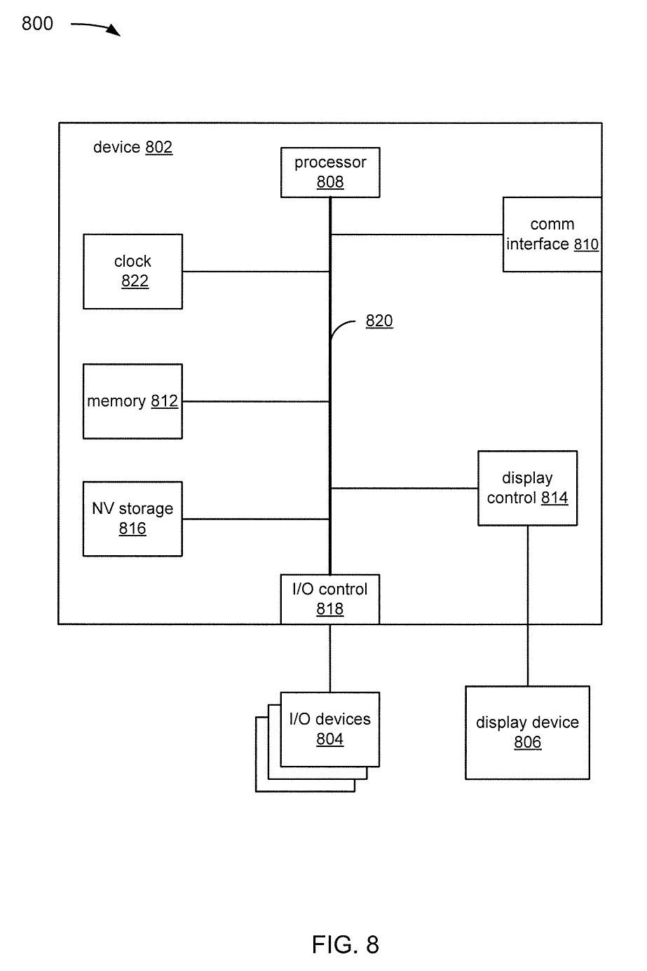

FIG. 1 depicts an example of a system 100 for providing new content to a business organization and receiving a contextualized object associated with the new content. FIG. 1 includes a personal system 102 and a common business ontology system 104. The personal system 102 and the common business ontology system 104 can be implemented on one or more computer systems. In the case of multiple computer systems, the multiple computer systems can be networked together. An example of a system that could be used to implement the personal system 102 and/or the common business ontology system 104 is described later with reference to FIG. 8.

In the example of FIG. 1, the personal system 102 can obtain or generate content and communicate the content to other personal systems (not shown). Content communicated by the personal system 102 may or may not be used to define relationships between a human or software entity associated with the personal system 102 and other entities associated with other personal systems. In an embodiment where the personal system 102 is storage-constrained (e.g., where the personal system 102 is implemented on a laptop or PDA of an individual), the personal system 102 may be unable to store all objects for all contexts used by the personal system 102. When a contextualized object is needed but not locally available, the personal system 102 must retrieve it, and may, for example, be subject to security clearance.

In the example of FIG. 1, the common business ontology system 104 can store all objects for all contexts of a business organization. The common business ontology system 104 can also, by way of example but not limitation, create and maintain an ontology in the normal course of business as human and/or software agents interact and communicate with one another. The common business ontology system 104 associates new content with relevant contexts using, by way of example but not limitation, the identity of the agent that generated the content; the identity of any agents that touched, forwarded, and/or modified the content; the identity of the agent that received the content; an explicit association with an entity, a role, a context, or some other object; an implicit association derived from a text search of the content; etc. Thus, the common business ontology system 104 can receive a new object; contextualize data associated with the new object, which may or may not include all of the data provided with the new object and may or may not include additional data that was not necessarily provided with or explicitly associated with the new object prior to contextualization; and store the contextualized data in one or more contextualized objects as part of the business organization. As used in this paper, “contextualization” can refer to either contextualization as just described, or both the identification of content as associated with a context and storage of contextualized object(s) associated with the content, unless a distinction between contextualization of content and storage of contextualized objects is explicitly intended.

In the example of FIG. 1, in operation, the personal system 102 provides new content 106 to the common business ontology system 104. The new content 106 can be an “object” as defined above. In this example the new content 106 is “new” because the new content 106 is assumed, for illustrative purposes, not to have been previously introduced to the common business ontology system 104.

In the example of FIG. 1, in operation, the common business ontology system 104 identifies a context for association with the new content 106. Since it is assumed that the content is new for illustrative purposes, the common business ontology system 104 contextualizes and stores at least some of the new content 106 as one or more contextualized objects.

The common business ontology system 104 can, by way of example but not limitation, use a taxonomy to contextualize the new content 106. The taxonomy can be used by the common business ontology system 104 to identify roles within contexts, e.g. project manager, programmer. The roles can be stored in the common business ontology system 104 in association with human or software agents performing the roles. For example, the taxonomy can be used to identify the role of the creator, the sender, the recipient, or any other human or software agent that is identified or identifiable from the new content 106 and/or associated data (e.g., data from a header, where the new content is payload). The role can be used to facilitate placement of the new content 106 in an appropriate context.

It may be noted that if the new content 106 were not “new,” the common business ontology system 104 could dispose of the content as duplicative, perhaps with relevant log updates showing that the content was redundantly received. However, the exact treatment of redundant content is not critical for an understanding of the example of FIG. 1.

It may further be noted that if the new content 106 were not relevant to any context (e.g., Spam), the common business ontology system 104 could dispose of the content as irrelevant, such as by deleting the content, marking the content as garbage, or storing the content without an associated context, perhaps marked for a review for relevance. However, the exact treatment of irrelevant content (as in, not associated with any context) is not critical for an understanding of the example of FIG. 1.

In this example, after the new object 106 is contextualized, the contextualized object 108 can be stored by the common business ontology 104 and can be provided to the personal system 102.

In the example of FIG. 1, in operation, the personal system 102 can retrieve a contextualized object 108 associated with the new content 106. It is assumed that since the personal system 102 provided the new content 106 that the personal system 102 can access the contextualized object 108, but this may or may not be the case. For example, a customer might send new content that deserves to be contextualized, but the common business ontology system 104 may determine that the customer does not have clearance to view the content as contextualized within the system.

In general, individuals can retrieve the contextualized object 108 if they have security clearance, which may depend upon the context, the role of the individual within the context, and/or the role of the individual with respect to the business organization. Depending upon the implementation, objects can be securely encrypted so that only individuals having clearance to retrieve the content can do so. In this way, a context can be configured so that an individual associated with the context can retrieve all objects within the context, or is restricted to a subset of the objects within the context that is appropriate given the individual's role in the context.

It should be noted that retrieval of the conceptualized object 108 presumes at least read access to the conceptualized object 108. However, the conceptualized object 108 may or may not include all content associated with the new content 106, and an individual using the personal system 102 may or may not be given write access to the conceptualized object. For example, where the personal system 102 retrieves the conceptualized object 108 and changes are made by an individual without write access, those changes may be treated as “new content” by the common business ontology system 104, and entered into the system as the equivalent of “tracked changes” for acceptance by an individual with write access to data associated with the conceptualized object 108. On the other hand an individual with write access who makes changes to the contextualized object 108 at the personal system 102 can send the new content 106 and overwrite data that is contextualized within the common business ontology system 104.

Depending upon the implementation, the system 100 could also be configured such that the personal system 102 never enables write access to the contextualized object 108, thereby, for example, ensuring that each revision of data is retained, unless, for example, the “tracked changes” are accepted at the common business ontology system 104. This can at least in part help safeguard against remote manipulation of data if that is considered undesirable.

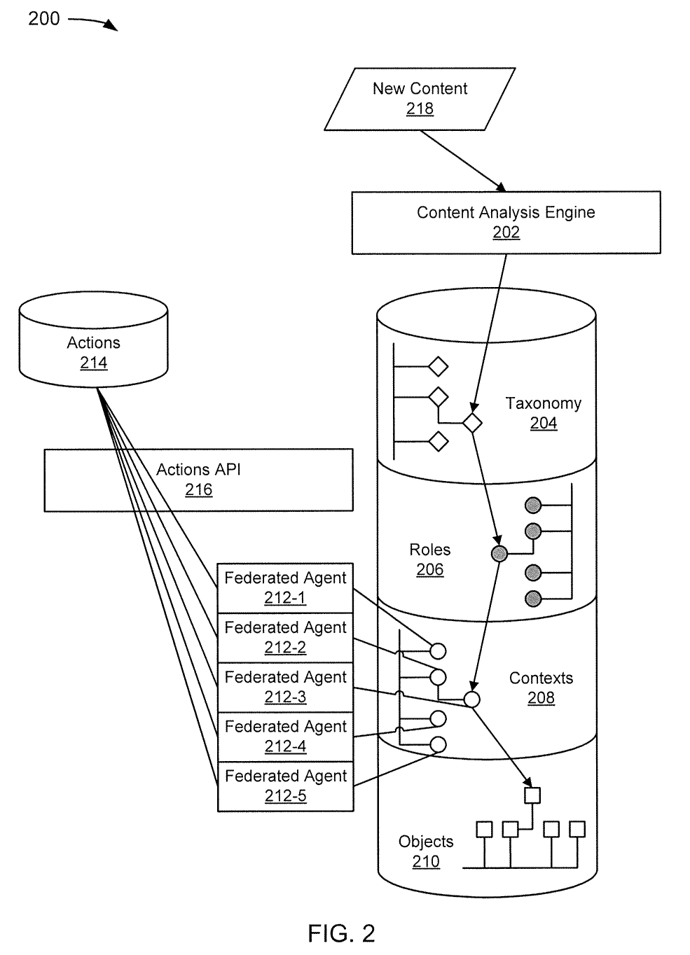

FIG. 2 depicts an example of a common business ontology system 200. FIG. 2 includes a content analysis engine 202, a taxonomy tree 204, a roles tree 206, a contexts tree 208, an objects tree 210, federated agents 212-1 to 212-5 (collectively federated agents 212), an actions database 214, and an actions application programming interface (API) 216. It should be noted that five federated agents 212 are depicted for illustrative reasons only because five contexts are depicted in the contexts tree 208.

In the example of FIG. 2, the content analysis engine 202 includes an interface (not shown) through which new content can be received. As used in this paper, an engine includes a processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

In the example of FIG. 2, the taxonomy tree 204 includes classifications (represented as triangles in the taxonomy tree 204) of various roles found in an organization. The taxonomy tree 204 may be useful in classifying roles played by individuals within a particular context. A role is typically associated with more than one name, such as where groups refer to the same role by different names, or where the groups use more than one language. The same role, for example, “manager” can be referred to as, for example, “ [symbol] ” or “ [symbol] ” in Japanese, “group leader” or “project head” in a particular company, and perhaps “head-honcho” informally to refer to the position in general or as a nickname for a particular manager. Thus, it may be desirable to include a global taxonomy that is useful for identifying foreign language translations or known synonyms of words, and a local taxonomy for identifying industry- or organization-specific uses of words. Such global and/or local taxonomies may or may not include informal synonyms, as well, depending upon preferences.

A tree, as used in this paper, can be stored in any applicable known or convenient data structure. For example, the tree can be stored as a linked list, a database, or some other data structure. Although the tree will typically have tree-like functionality in a typical implementation (e.g., a taxonomy tree will likely have a root word with a plurality of synonyms as child nodes), it is possible to store a tree in a data structure not typically associated with a tree, such as an array or a table. Thus, when a data structure in this paper is referred to as a “tree,” it should be understood that the data can be represented as a tree, but the underlying data structure can have any applicable known or convenient format.

In the example of FIG. 2, the roles tree 206 includes roles (represented as shaded circles in the roles tree 206) that can be associated with various contexts. Each role may include prerequisites for the role, such as minimum expertise or hierarchical position within the organization; rank-based responsibility within the context, such as an identification of a supervisor and/or an assistant; task-based responsibility associated with the role, such as a requirement to prepare reports or assign tasks to others; or any other applicable known or convenient information. It may be noted that hierarchical position within an organization and with respect to a particular context are not always the same. For example a first individual could be manager in a first context and assistant in a second context, and a second individual assistant in the first context and manager in the second context, even if the first individual “outranks” the second individual in the organization as a whole.

In the example of FIG. 2, the contexts tree 208 includes contexts (represented as circles in the contexts tree 208) that are associated with a business organization. A context has a business purpose for existing, for example, “fundraising,” “operations,” and “asset acquisition,” and typically has at least one associated project or project-like activity. Individuals can have multiple roles in a context, and different roles in different contexts. A context can be a “root” context with no “child” contexts; a “parent” context, which may or may not be a “root” context, with one or more “child” contexts; or a “child” context. For example, say the president is in charge of asset acquisition (a “root” context) and a vice president is in charge of acquisition of a specific asset (a “child” context of the “root” context). Since the “root” context has a “child,” the “root” context can also be referred to as a “parent” context. The vice president may have no role in the parent context, but by virtue of having a role in the parent context, the president may automatically have a role in the child context.

It should be noted that having a role in a parent context does not necessarily give access to everything in a child context, but this is definitional in nature. For example, the human resource manager may have a role in human resource management of asset acquisition, which is a subset of asset acquisition, and therefore a role in human resource management of acquisition of a specific asset. This is definitional because the human resource management of asset acquisition can be defined as a peer of asset acquisition; human resource management of acquisition of a specific asset a child of human resource management of asset acquisition, and a peer of acquisition of a specific asset. In this way, in the contexts tree 208, human resource management can be a different branch from asset acquisition, even though the branches have some overlap, and the parent of the two branches, if any, includes a role that has access to both branches.

It should further be noted that it can be difficult to depict a contexts tree in a figure for a reasonably complex organization because the contexts can become intertwined. In the example of FIG. 2, the contexts tree 208 is depicted as having four parent nodes and one child node for illustrative purposes only.

In the example of FIG. 2, the objects tree 210 may include objects (represented as squares in the objects tree 210) associated with contexts stored in the contexts tree 208. Objects can include, by way of example but not limitation, emails, documents, presentations, executables, multimedia, or any other applicable known or convenient objects. The objects can be securely encrypted in a known or convenient manner to prevent unauthorized access to the objects.

The objects tree 210 and objects in the objects tree 210 can change over time. For example, an entity can provide new content, such as entirely new content or changes to content already associated with an object in the objects tree 210, from, for example, a personal system, a system located within a company firewall (if any), or some other device. Depending upon the implementation, embodiment, and/or source of the new content, the new content can be provided along with meta-data that helps to contextualize the new content. The meta-data may include information about the entity, a known context, an object to be modified using the new content, etc. When the new content is properly contextualized, an existing object is modified in or a new object is added to the objects tree 210.

In the example of FIG. 2, the federated agents 212 together comprise a “federated society” of agents, where each of the federated agents 212 has the power to perform actions on behalf of respective associated contexts. Each context has an agent, and each agent has a context. The federated agents 212 can be implemented as software entities stored in hardware (e.g., registers, memory, and/or non-volatile storage) and executed by a processor in a known or convenient fashion.

In the example of FIG. 2, the actions database 214 is coupled to the federated agents 212 through the actions API 216. The actions database includes, by way of example but not limitation, procedures, functions, or other tasks that can be performed by the federated agents 212. Using the actions API 216 the federated agents 212 can perform one or more of the actions in the actions database 214 in the context associated with the agent. In a non-limiting example, the actions include retrieving details associated with an object, saving a title or “handle” of a context, copying a taxonomy tree, or some other action associated with reading data from, writing data to, or otherwise managing the business organization.

In the example of FIG. 2 in operation, a new content 218 is received by the content analysis engine 202. For illustrative purposes, the new content 218 is assumed to be “new” because at least some content associated with the new content 218 has not been stored in the objects tree 210 and, also for illustrative purposes, the context with which to associate the new content 218 is initially unknown to the system 200.

It may be noted that if the context of the new content 218 is explicit, the content analysis engine 202 could be bypassed. However, as used in this paper, it is assumed that the content analysis engine 202 includes the database interface(s) at least to the objects tree 210. For example, if an object can be stored directly in the objects tree 210 by a human or software agent associated with a context, since the database interface for the objects tree 210 is considered “part of” the content analysis engine 202, the content would “pass through” the content analysis engine 202. Similarly, if content has an explicit context association identified in meta-data, the content analysis engine 202 is treated as having the logic that reads the meta-data and identifies the explicit context association.

In the example of FIG. 2, say the new content 218 is an email sent from a first entity, the content analysis engine 202 can use the taxonomy tree 204 to identify the first entity as a project manager, and the contents of the email include a note discussing the termination of a second entity, who is an employee. Perhaps the title project manager is used to identify the role of the first entity as that of a supervisor of the second entity in at least one context, and the potential termination of the employee is used to associate the new content 218 with a human resources context. In this example, the federated agent 212-3 is associated with the human resources context. The federated agent 212-3 uses an action from the actions database 214 via the actions API 216 to store a new object associated with the new content 218 in the objects tree 210 in association with the human resources context, and also in association with the first entity (who in this context may be assigned the role of “reporting supervisor”) and the second entity (who in this context may be assigned the role of “employee of interest”).

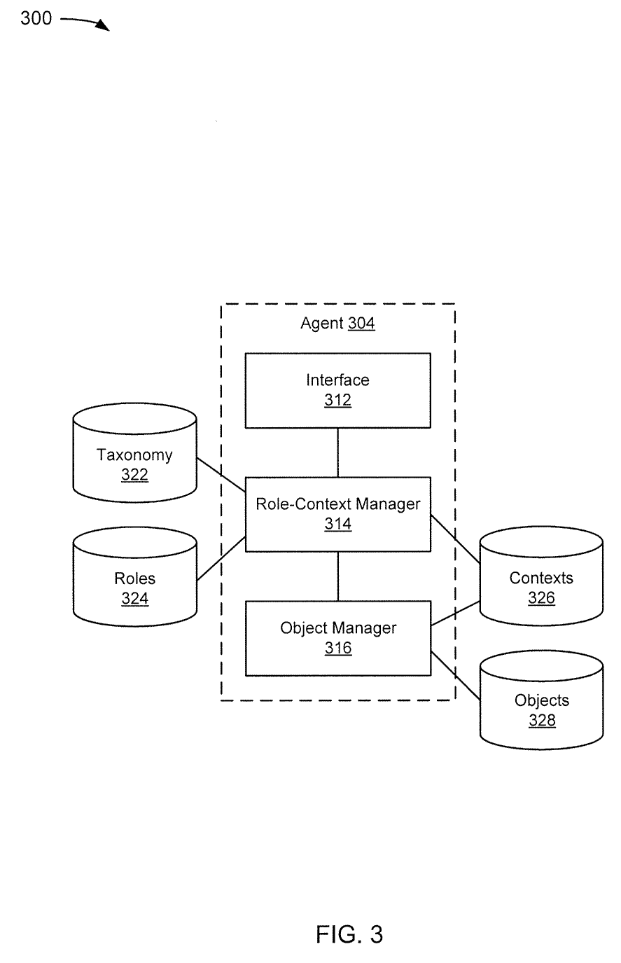

FIG. 3 depicts an example of an agent and associated modules (collectively, a system 300) for storing a contextualized object. FIG. 3 includes an agent engine 304, a taxonomy tree 322, a roles tree 324, a contexts tree 326, and an objects tree 328. The agent engine 304 includes an interface 312, a role-context manager 314, and an object manager 316.

In the example of FIG. 3, the interface 312 can include a module interpreting a command structure for transmitting and receiving objects, including commands, status reports, and other applicable known or convenient objects. The command structure can be defined in the extensible markup language (XML), simple object access protocol (SOAP), or another other applicable known or convenient protocol. In general, the interface 312 can include any applicable known or convenient devices that enable the agent engine 304 to carry out its intended function, including, by way of example but not limitation, an API to an actions database.

In the example of FIG. 3, the role-context manager 314 can compare characteristics, including parameters, meta-data, and other applicable characteristics of an object with data stored in a common business ontology system (as represented by the taxonomy tree 322, roles tree 324, and contexts tree 326, to which the role-context manager 328 is coupled). It may be noted that the role-context manager 314 might benefit from data in the objects tree 328. For example, if an object includes a document with a reference number sufficient to identify it as an object (or a revision of an object) in the objects tree 328, the role-context manager 314 could use the document number and the objects tree 328 to determine the appropriate context(s) of the document. However, because of the example described below, for illustrative reasons, the role-context manager 314 is coupled indirectly to the objects tree 328, through the object manager 316.

The role-context manager 314 can compare words found in an object with the taxonomy tree 322 and use the roles tree 324 to determine whether the words can be used to identify a role with which to associate the object. The role-context manager 316 can then use other characteristics of the object to identify one or more contexts from the contexts tree 326 for the identified role.

It should be noted that some objects may not include words that are found in the taxonomy tree 322. Also, depending upon implementation-, embodiment-, and/or content-specific issues, the role-context manager 316 may not be able to identify a known role with which to (at least potentially) associate the object. So the role-context manager 314 may need to create a new context, which may or may not be temporary. The new context might be temporary if an appropriate existing context is later identified for association with the object. For new contexts, at least the role “provider of the object” can normally be created, since the object has to come from somewhere. Of course, the system 300 can make mistakes so, for example, a spoofed email sender could be recorded as the “provider of the object.” In any case, when control passes from the role-context manager 314 to the object manager 316, it can be assumed that an object has at least one context, and the contexts are each associated with at least one role, which may or may not be the same role for each.

In the example of FIG. 3 object manager 316 can store objects in association with a context and role (either explicitly or implicitly) or retrieve objects associated with a particular context and role, depending upon the action being taken by the agent engine 304. When storing an object, the object manager 316 can include an identifier (e.g., as a document reference number) in the objects tree 328. Similarly, the object manager 316 can store the identifier in each relevant context the contexts tree 326. Advantageously, the object is stored in only one place in the objects tree 328, but appears to be stored in each relevant context. This enables cross-contextual collaboration, prevents multiple different versions of an object from being saved on the system 300, and can save space.

In the example of FIG. 3, in operation, the external interface 312 can receive an object access request from an entity. The object access request, at a basic level, can be a request to write new content to an object (including creating a new object, if appropriate) or a request to read content associated with an object.

Say the object access request is a read request for a “budget presentation” object by an entity identifiable as the CFO, either by using the taxonomy tree 322 or because the CFO explicitly identifies herself. The role-context manager 314 uses the title CFO is used to identify the role of the entity as that of “editor” of the “budget presentation” object in a “fiscal” context, and obtains an identifier for the “budget presentation” object.

The object manager 316 uses the identifier to read the “budget presentation” object. At this point, the object may be “checked out” with write privileges to prevent other entities with write access to the object (e.g., a CEO) from changing the object while checked out to the CFO. Depending upon the implementation, the CFO may or may not be able to read the budget presentation object without checking it out so that, for example, another entity would be able to change the object in the meantime.

After the “budget presentation” object is read, it can be sent via the interface 312 to the requesting entity. Later, assuming the entity has write access, a new version of the “budget presentation” object can be received on the interface 312, and the objects tree 328 can be updated accordingly.

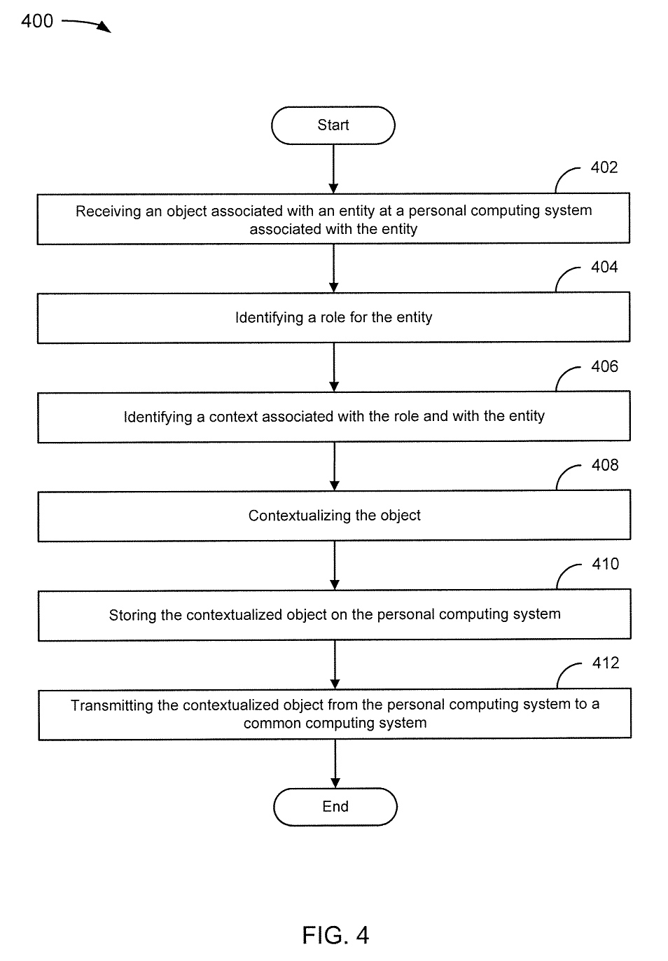

FIG. 4 depicts a flowchart 400 of an example of a method for storing a new object in a personal system in association with a context. The method is organized as a sequence of modules in the flowchart 400. However, it should be understood that these and modules associated with other methods described herein may be reordered for parallel execution or into different sequences of modules.

In the example of FIG. 4, the flowchart 400 starts at module 402 with receiving an object associated with an entity at a personal computing system also associated with the entity. A common business ontology system can receive the object. The object may be part of an ongoing project involving the entity and other individuals in an organization managing the objects using the common business ontology system. In a non-limiting example, an individual may have created a presentation and has shared it with other individuals.

The object may be secured and indexed. Indexing, such as for searching, is discussed in U.S. Patent Application Ser. No. 61/042,233 entitled “PERSONALIZED SCREENING OF CONTEXTUALLY RELEVANT CONTENT,” which is incorporated by reference.

Meta-data associated with the object may be used to identify the object and store additional information such as tracked-changes, dates, times, and other useful information. A personal computing system may index the object for addition to the common business ontology system thereby relieving the common business ontology system from indexing the object. By distributing the indexing over many personal computing systems, the common business ontology system can be relieved of a large amount of processing work. The object may have a security classification associated with it to prevent authorized entities from accessing the object.

In the example of FIG. 4, the flowchart 400 continues to module 404 with identifying a role for the entity. The entity may be an individual or an automated process. The entity providing the object may specify the role of the entity. Alternatively, a role may be identified for the entity by looking up the roles played by the entity and analyzing the object. Depending upon the data associated with the object, it may be desirable to use a taxonomy tree managed by a common business ontology system to identify an entity associated with the object.

In the example of FIG. 4, the flowchart 400 continues to module 406 with identifying a context associated with the role and with the entity. The entity can explicitly identify a context for the object. Meta-data included in the object may or may not be stored in association with the context. Where the entity does not explicitly identify a context, the meta-data can be used to determine context. It should be noted that in some cases, a context can be identified for an object prior to identifying a role within the context.

In the example of FIG. 4, the flowchart 400 continues to module 408 with contextualizing the object. Since the context is known at this point, it is straight-forward to contextualize the object. The module 408 could even be considered inherent with respect to the module 406.

In the example of FIG. 4, the flowchart 400 continues to module 410 with storing the contextualized object on the personal computing system. The personal computing system can hold copies of contextualized objects that have not yet been transmitted to the common computing system. The copies can also be retained at the personal computing system after contextualized objects are transmitted to the common computing system, and can make up a subset of the contextualized objects stored by the common computing system.

In the example of FIG. 4, the flowchart 400 continues to module 412 with transmitting the contextualized object from the personal computing system to a common computing system. There, the contextualized object is stored along with the rest of the objects managed by the common computing system. Having transmitting the contextualized object from the personal computing system to a common computing system, the flowchart terminates.

Advantageously, in a system that includes a plurality of networked personal computing systems, where the personal computing systems retain copies of the contextualized objects, a database of contextualized objects can be distributed. While it may be advantageous to keep copies of the contextualized objects stored in a central location, certain activities, such as indexing, can be accomplished in a distributed fashion, freeing up resources at the central location. Also, personal computing systems sometimes go offline. It may be advantageous to continue providing context to objects so that when the personal computing system comes back online, the contextualized objects can be sent and easily integrated into the common system. In addition, contextualizing content at a personal computer system can conceivably free up some resources at the common system.

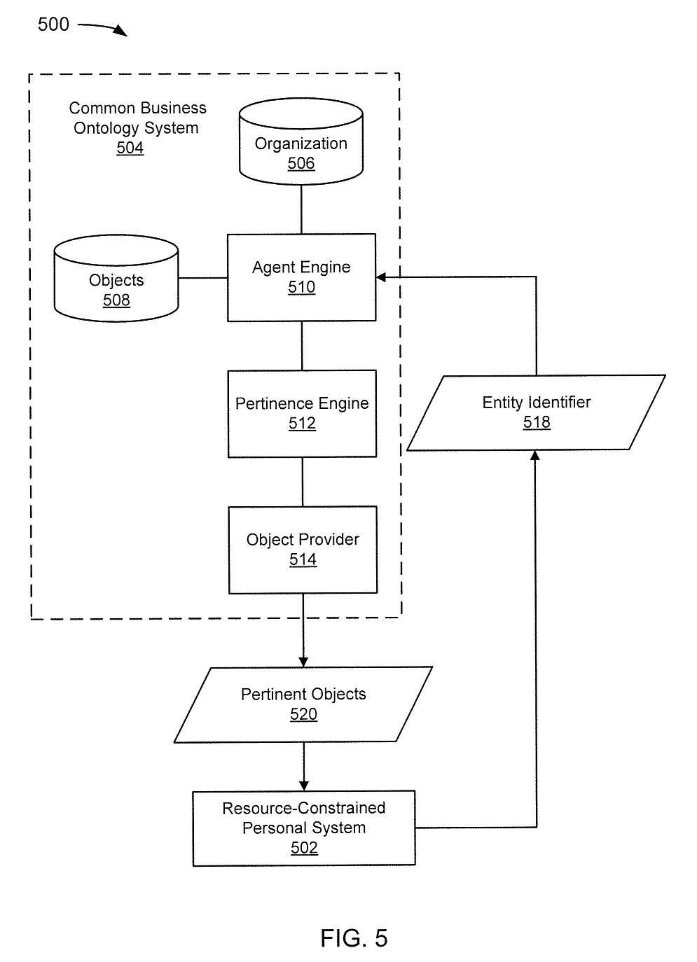

FIG. 5 depicts an example of a system 500 in which pertinent objects are provided to a resource-constrained personal system. The system 500 includes a resource-constrained personal system 502 and a common business ontology system 504.

In the example of FIG. 5, the resource-constrained personal system 502 can be similar to personal computing systems described elsewhere in this paper. For illustrative purposes, in the example of FIG. 5, the personal computing system is limited in some way. For example, the resource-constrained personal system 502 may have access to low bandwidth, which makes high-volume downloads difficult or impractical. As another example, the resource-constrained personal system 502 could a device with limited storage capacity or display capabilities, such as a PDA. Thus, at times, the resource-constrained personal system 502 may have resources to accept only a limited number of objects.

It should be noted that in some cases, the resource-constrained personal system 502 might have what one might consider “normal” resource capabilities, but be constrained because of the amount of data to which a user of the system is permitted access. For example, a CEO on his laptop may be entitled to view a huge amount of data located at a central repository for a company, but even a high-quality laptop is unlikely to be able to store all of the data of a relatively large company. Therefore, for the CEO, the laptop might be considered resource-constrained, while for another employee of the company an equivalent laptop might be able to handle all data to which the employee has access.

In the example of FIG. 5, the common business ontology system 504 includes an organization database 506, an objects tree 508, an agent engine 510, a pertinence engine 512, and an object provider 514. The organization database 506 can include, by way of example but not limitation, a taxonomy tree, a roles tree, and a context tree, such as are described elsewhere in this paper. The objects database 508 could be considered part of the organization database 506, and is depicted as distinct for the purposes of illustration only. The objects database 508 can include objects that are associated with contexts and roles stored in the organization database 506.

The agent engine 510 can be similar to the agent engine 304 (FIG. 3). Strictly speaking, the pertinence engine 512 could be considered part of the agent engine 510 and the object provider 514 could be considered part of an interface of the agent engine 510, and they are depicted as distinct for the purposes of illustration only.

In the example of FIG. 5, in operation, the resource-constrained personal system 502 provides an entity identifier 518 to the agent engine 510. The entity identifier 518 can include a user name or user identifier and can be associated with a human or software agent. The entity identifier 518 may also include information about the user of the resource-constrained personal system 502 or the resource-constrained personal system 502, such as a quantification of the extent of the constraint on resources. The agent engine 510 consults the organization database 506 to identify objects in the objects database 508 to which an entity associated with the entity identifier 518 is entitled access. Depending upon the implementation and/or configuration, the objects can include associated meta-data.

In the example of FIG. 5, in operation, the pertinence engine 512 ranks the objects according to a scoring system. For illustrative purposes, objects with higher pertinence are given higher scores than objects with lower pertinence. Pertinence always takes into consideration the role of the entity that is to receive the objects, either explicitly or implicitly. For example, in an “emergency” alert to all employees, the role of “employee” could be implicit in the context of the alert, while for typical object provisioning, the role of the recipient is, at least in some cases, the only convenient way that the pertinence of the object can be determined. As a general rule, objects that the system 504 has reason to expect will be worked on soon by the recipient will have higher pertinence than objects that the system 504 has reason to expect will be worked on later. Also, new objects will tend to have higher pertinence than old objects. For example, unread email might have more pertinence than email that has been read, but has not been uploaded to the resource-constrained personal system 502. Another possible way to adjust pertinence is by the size of the object. Although size may not appear to have any bearing on pertinence, uploading large objects can have an impact on other resource-constrained personal systems that are trying to obtain pertinent objects at the same time.

In an implementation, the pertinence engine 512 can be configured by a human or software agent and may or may not include the preferences of the entity. For example, a systems administrator might be able to decrease pertinence for objects across the board at high-traffic times, such as the start of a business day, so that entities only receive truly pertinent objects at that time. As another example, an employee who knows he will be significantly resource-constrained could inform the system 504 of his expected resource limitations, either in advance or at the time the entity identifier 518 is provided. If the pertinence engine 512 is aware of resource constraints, it could set pertinence scores below a certain value to zero so that they are not provided.

In the example of FIG. 5, in operation, the object provider 514 can provide pertinent objects 520 in order of pertinence. For the purposes of this example, objects must be pertinent for the object provider 514 to provide them.

In one implementation, a time window can be set to determine pertinence. The window may be set to provide an individual all of the objects that she will need while disconnected from a common system. For example, say an individual plans to travel for two weeks. The pertinent objects 520 can include those objects likely to be used in the proximate two weeks. In this example, the pertinent objects 520 can be marked for download because the objects are relevant within a time interval for which an entity will be disconnected from a common system.

Pertinence can be scored based upon a context, such as by identifying meetings or emails and associating them with a context identifier. The pertinence of a context can also have a bearing on the pertinence of objects associated with the context. More than one scoring method can be used, and the pertinence can be defined by aggregating more than one scoring method.

Since the personal system is resource-constrained, content can be kept for a limited amount of time. In such an implementation, it may be desirable to have pertinence scores associated with objects stored on the resource-constrained personal system 502. As objects lose pertinence, the objects could be deleted or uploaded to the central repository automatically. It may be desirable to enable a person to flag objects for deletion or uploading (essentially explicitly defining the objects as not pertinent) or to lock objects so that the system cannot take it away when it determines some other object of higher pertinence should replace it (essentially explicitly defining the objects as highly pertinent). In general, when pertinence is reduced to zero, objects are likely to be preferentially stored on a common system, and not the resource-constrained personal system 502.

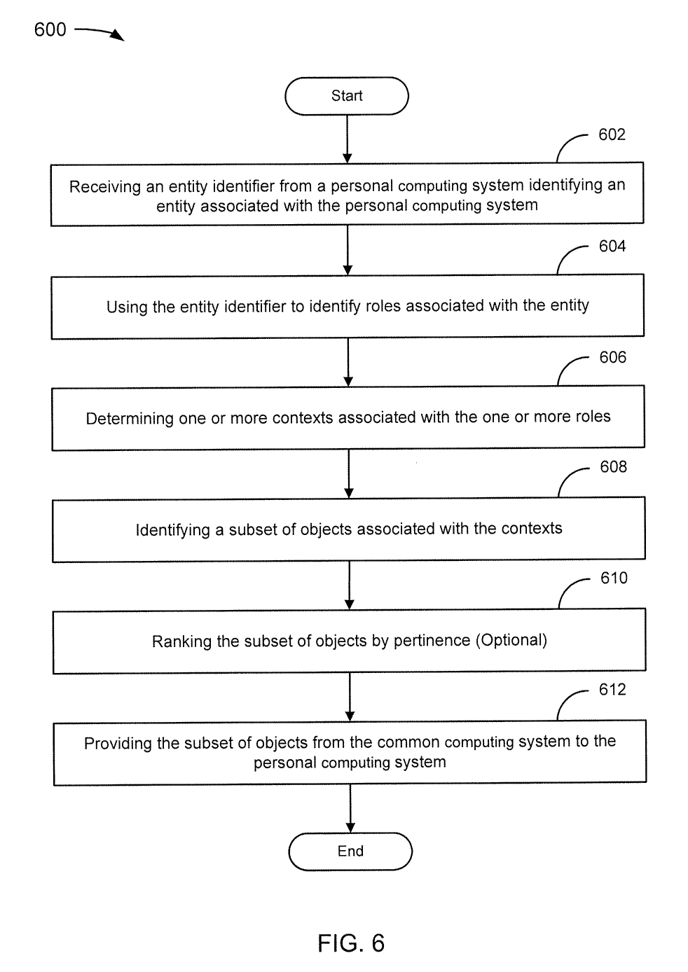

FIG. 6 depicts a flowchart 600 of an example of a method for providing pertinent objects from a common system to a personal system. The method is organized as a sequence of modules in the flowchart 600. However, it should be understood that these and modules associated with other methods described herein may be reordered for parallel execution or into different sequences of modules.

In the example of FIG. 6, the flowchart 600 starts at module 602 with receiving an entity identifier from the personal system identifying an entity associated with the personal computing system. An entity may be a human or software agent that provides the entity identifier in a message. The entity identifier can be provided in a message that may or may not include a request to download pertinent objects.

In the example of FIG. 6, the flowchart 600 continues to module 604 with using the entity identifier to identify roles associated with the entity. Since, in this example, the entity is explicitly providing the entity identifier, it is probably not necessary to use a taxonomy tree. An entity can have one or more associated roles within an organization, such as, by way of example but not limitation, editor, manager, supervisor, advisor, etc. It is likely that all roles for a person in the organization can be identified using the entity identifier, but this is not required. Also, a person could conceivably have more than one entity identifier, with different associated roles.

In the example of FIG. 6, the flowchart 600 continues to module 606 with determining one or more contexts associated with the one or more roles. Since a person's roles are always associated with a context in the organization, by identifying roles, it is relatively straight-forward to determine contexts associated with the entity identifier.

In the example of FIG. 6, the flowchart 600 continues to module 608 with identifying a subset of objects associated with the contexts. Objects are always stored in association with a context. So if a context is known, it is relatively straight-forward to identify objects associated with the context. However, not all objects are necessarily available to every role associated with the context. For example, employee evaluations might be associated with a project, but only the supervisor (and perhaps other entities in peer contexts) are allowed access to the employee evaluations. Thus, the objects identified can actually be a subset of all of the objects associated with the context, depending upon the role associated with the entity identifier.

In the example of FIG. 6, the flowchart 600 continues to optional module 610 with ranking the subset of objects by pertinence. This module is optional because it is not necessary to rank objects by pertinence unless there is a resource constraint. It should be noted that some implementations could always have pertinence-ranking in effect in order to control the amount of traffic. For example, after higher-pertinence objects are provided to all requesting entities, lower-pertinence objects might be provided, at least until new objects with higher pertinence are added to the system and need to be distributed.

In the example of FIG. 6, the flowchart 600 continues to module 612 with providing the subset of objects from the common computing system to the personal computing system. Having provided the one or more objects to the personal system, the flowchart terminates. It should be noted that if the module 610 is implemented (i.e., objects are ranked by pertinence), a subset of the subset of objects is actually provided. This subset of the subset of objects can be referred to as the pertinent objects.

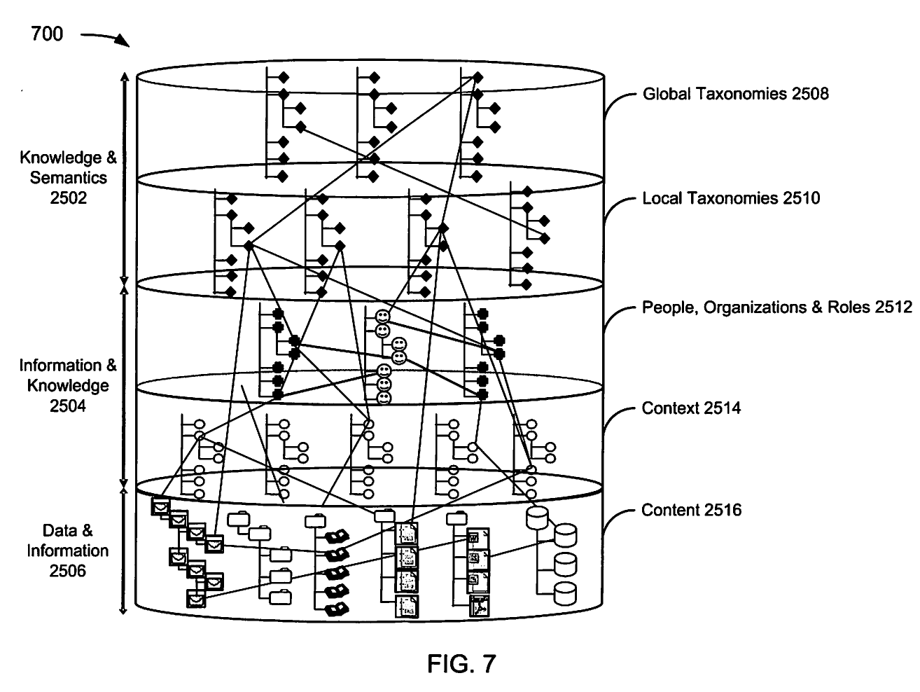

FIG. 7 depicts a diagram 700 of an example of an ontological representation of knowledge of a business organization. The diagram 700 includes taxonomies, roles, people, and content. Such a representation graphically depicts links between objects, roles, people and taxonomies.

FIG. 8 depicts an example of a system 800 appropriate for implementing one or more of the systems described in this paper. The system 800 may be a conventional computer system that can be used as a client computer system, such as a wireless client or a workstation, or a server computer system. The system 800 includes a device 802, I/O devices 804, and a display device 806. The device 802 includes a processor 808, a communications interface 810, memory 812, display controller 814, non-volatile storage 816, I/O controller 818, clock 822. The device 802 may be coupled to or include the I/O devices 804 and display device 806.

The device 802 interfaces to external systems through the communications interface 810, which may include a modem or network interface. It will be appreciated that the communications interface 810 can be considered to be part of the system 800 or a part of the device 802. The communications interface 810 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 808 may be, for example, a conventional microprocessor such as an Intel Pentium microprocessor or Motorola power PC microprocessor. The memory 812 is coupled to the processor 808 by a bus 820. The memory 812 can be Dynamic Random Access Memory (DRAM) and can also include Static RAM (SRAM). The bus 820 couples the processor 808 to the memory 812, also to the non-volatile storage 816, to the display controller 814, and to the I/O controller 818.

The I/O devices 804 can include a keyboard, disk drives, printers, a scanner, and other input and output devices, including a mouse or other pointing device. The display controller 814 may control in the conventional manner a display on the display device 806, which can be, for example, a cathode ray tube (CRT) or liquid crystal display (LCD). The display controller 814 and the I/O controller 818 can be implemented with conventional well known technology.

The non-volatile storage 816 is often a magnetic hard disk, flash memory, an optical disk, or another form of storage for large amounts of data. Some of this data is often written, by a direct memory access process, into memory 812 during execution of software in the device 802. One of skill in the art will immediately recognize that the terms “machine-readable medium” or “computer-readable medium” includes any type of storage device that is accessible by the processor 808 and also encompasses a carrier wave that encodes a data signal.

Clock 822 can be any kind of oscillating circuit creating an electrical signal with a precise frequency. In a non-limiting example, clock 822 could be a crystal oscillator using the mechanical resonance of vibrating crystal to generate the electrical signal.

The system 800 is one example of many possible computer systems which have different architectures. For example, personal computers based on an Intel microprocessor often have multiple buses, one of which can be an I/O bus for the peripherals and one that directly connects the processor 808 and the memory 812 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 812 for execution by the processor 808. A Web TV system, which is known in the art, is also considered to be a computer system, but it may lack some of the features shown in FIG. 8, such as certain input or output devices. A typical computer system will usually include at least a processor, memory, and a bus coupling the memory to the processor.

In addition, the system 800 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 816 and causes the processor 808 to execute the various acts required by the operating system to input and output data and to store data in memory, including storing files on the non-volatile storage 816.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

It will be appreciated to those skilled in the art that the preceding examples are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of these teachings.

What is claimed is:

1. A system comprising:
a taxonomy tree that includes classifications of various roles found in an organization;
a roles tree that includes entries associated with roles that can be associated with contexts;
a contexts tree that includes entries associated with the contexts;
an objects tree that includes objects associated with the contexts;
a role-context manager coupled to the taxonomy tree, the roles tree, and the contexts tree;
an object manager coupled to the role-context manager, the contexts tree, and the objects tree;
wherein, in operation,
the role-context manager compares a word found in an object with the taxonomy tree and the roles tree to identify a role with which to associate the object;
the role-context manager compares a characteristic associated with the object to identify one or more contexts from the contexts tree for the identified role;
the object manager stores the object in the objects tree in association with the role and the one or more contexts.

2. The system of claim 1 wherein the role-context manager and the object manager are distributed across a plurality of federated agents that are respectively associated with the contexts.

3. The system of claim 2, further comprising an actions application programming interface (API) coupling a federated agent of the federated agents to an actions database that includes tasks that can be performed by the federated agent.

4. The system of claim 1, further comprising a content analysis engine that finds the word in the object.

5. The system of claim 1, further comprising a content analysis engine that determines the characteristic associated with the object from meta-data associated with the object.

6. The system of claim 1 wherein a unique object identifier associated with the object is stored in association with each of the one or more contexts.

7. The system of claim 1 wherein the object is a second object, wherein the second object includes tracked-changes to a first object.

8. The system of claim 7, wherein the second object replaces the first object in storage when the object manager stores the second object.

9. The system of claim 7, wherein the second object is stored in association with the first object when the object manager stores the second object.

10. The system of claim 1, further comprising an interface, coupled to the role-context manager, that includes a module that interprets a command structure for transmitting and receiving the object.

11. A method comprising:
receiving an object associated with an entity at a personal computing system associated with the entity;
identifying a role for the entity;
identifying a context in which the entity has the role;
contextualizing the object;
storing the contextualized object on the personal computing system;
transmitting the contextualized object from the personal computing system to a common computing system.

12. The method of claim 11 further comprising indexing the contextualized object.

13. The method of claim 11 further comprising verifying the entity has a sufficient level of security access to the object before transmitting the object to the common computing system.

14. The method of claim 11, further comprising waiting while the personal computing system is offline, wherein the transmitting occurs when the personal computing system is online.

15. The method of claim 11, wherein the contextualizing the object at the personal computing system is in lieu of contextualizing the object, at least for the identified context, at the common computing system.

16. A system comprising:
a common business ontology system including:
an organization database;
an objects database;
an agent engine coupled to the organization database and objects database;
a pertinence engine coupled to the agent engine;
an object provider coupled to the pertinence engine;
wherein, in operation,
the agent engine uses an entity identifier, associated with an entity, from a personal computing system to find a context and a role of the entity in the context in the organization database;
the agent identifies objects associated with the role and the context in the objects database;
the pertinence engine identifies a subset of the objects as pertinent objects;
the object provider provides the pertinent objects to the personal computing system.

17. The system of claim 16 further comprising a resource-constrained personal system associated with the entity.

18. The system of claim 16 wherein the pertinence engine identifies an object as pertinent because the object is relevant within a time interval for which an entity will be disconnected from the common computing system.

19. The system of claim 16 wherein the pertinence engine identifies the pertinent objects using, at least in part, a preference associated with the entity.

20. The system of claim 16 wherein the pertinence engine identifies the pertinent objects using, at least in part, a configuration by a human or software agent.
